(19) United States
(12) Patent Application Publication
(10) Pub. No.: US 2026/0286751 A1
(43) Pub. Date: Sep. 24, 2026

(54) VEHICLE REAR DOOR ASSEMBLY

(71) Applicant: NISSAN NORTH AMERICA, INC., Franklin, TN (US)

(72) Inventors: David KOVIE, Livonia, MI (US); Luke CORDES, Bloomfield Hills, MI (US); Ronald MORROW, Novi, MI (US); Christopher HERRALA, Milford, MI (US); Srinkanth Reddy BADDAM, Northville, MI (US)

(21) Appl. No.: 19/085,972

(22) Filed: Mar. 20, 2025

(51) Int. Cl. E05B 83/16; E05B 79/04; E05B 81/22; E05B 85/04

(52) U.S. Cl. CPC E05B 83/16; E05B 79/04; E05B 85/04; E05B 81/22

(57) ABSTRACT

A rear door assembly for a vehicle includes a vehicle body structure and a roof panel connected to the vehicle body structure. An opening is disposed in the vehicle body structure. A rear door is pivotally connected to the vehicle body structure and configured to overlay the opening in a closed position. A first striker is connected to the roof panel. A first latch member is connected to the rear door. The first latch member is configured to engage the first striker upon moving the rear door to the closed position. The first latch member is configured to disengage the first striker upon moving the rear door to an open position.

### BACKGROUND

### Technical Field

The present disclosure generally relates to vehicle rear door assembly. More specifically, the present disclosure generally relates to a first striker connected to a roof panel configured to receive a first latch member upon moving the rear door to a closed position.

### Background Information

A rear door assembly of a vehicle, such as a sport utility vehicle (SUV), typically pivots rearward and upward. An electric motor typically couples to a portion of the rear door to move the rear door between an open position and a closed position.

### SUMMARY

A need exists for a vehicle rear door assembly in which a rear door of a vehicle is securely connected to a vehicle body structure in a closed position.

In view of the state of the known technology, one aspect of the present disclosure is to provide a rear door assembly for a vehicle including a vehicle body structure and a roof panel connected to the vehicle body structure. An opening is disposed in the vehicle body structure. A rear door is pivotally connected to the vehicle body structure and configured to overlay the opening in a closed position. A first striker is connected to the roof panel. A first latch member is connected to the rear door. The first latch member is configured to engage the first striker upon moving the rear door to the closed position. The first latch member is configured to disengage the first striker upon moving the rear door to an open position.

Another aspect of the present disclosure is to provide a vehicle rear door assembly including a vehicle body structure, a roof panel connected to the vehicle body structure, and a bottom panel connected to the vehicle body structure. An opening is disposed in the vehicle body structure. A first striker is connected to the roof panel. A second striker is connected to the bottom panel. A rear door overlays the opening in a closed position. A first latch member is connected to the rear door. A second latch member is connected to the rear door. The first latch member is configured to engage the first striker and the second latch member is configured to engage the second striker upon moving the rear door to the closed position. The first latch member is configured to disengage the first striker and the second latch member is configured to disengage the second striker upon moving the rear door to an open position.

Also other objects, features, aspects and advantages of the disclosed vehicle rear door assembly will become apparent to those skilled in the art from the following detailed description, which, taken in conjunction with the annexed drawings, discloses exemplary embodiments of the vehicle rear door assembly.

### BRIEF DESCRIPTION OF THE DRAWINGS

Referring now to the attached drawings which form a part of this original disclosure:

FIG. 1 is a side elevational view of a vehicle in which a rear door is in a closed position in accordance with an exemplary embodiment;

FIG. 2 is a side elevational view of the vehicle of FIG. 1 in which the rear door is moved to a first intermediate position;

FIG. 3 is a side elevational view of the vehicle of FIG. 1 in which the rear door is moved to a second intermediate position;

FIG. 4 is a side elevational view of the vehicle of FIG. 1 in which the rear door is moved to a third intermediate position;

FIG. 5 is a side elevational view of the vehicle of FIG. 1 in which the rear door is moved to a fully open position;

FIG. 6 is a rear elevational view of the vehicle of FIG. 1 in which the rear door is in the closed position;

FIG. 7 is a rear view of the vehicle of FIG. 4 in which the rear door is in the fully open position;

FIG. 8 is a rear perspective view of the vehicle of FIG. 7 illustrating a first striker and a second striker;

FIG. 9 is an exploded assembly view of a roof panel of the vehicle of FIG. 1;

FIG. 10 is an elevational view in cross section of a roof panel of FIG. 9;

FIG. 11 is an elevational view in cross section of a first latch member engaging a first striker of the roof panel of FIG. 9;

FIG. 12 is an elevational view in cross section of a roof panel in which a first latch member engages a first striker in accordance with another exemplary embodiment;

FIG. 13 is a perspective view of the first latch member engaging the first striker of FIG. 12;

FIG. 14 is a lower perspective view of the first striker of FIG. 12;

FIG. 15 is an elevational view in cross section of the roof panel of FIG. 12 in which a second latch member engages a second striker;

FIG. 16 is an elevational view in cross section of the roof panel of FIG. 15.

Also other objects, features, aspects and advantages of the disclosed vehicle rear door assembly will become apparent to those skilled in the art from the following detailed description, which, taken in conjunction with the annexed drawings, discloses exemplary embodiments of the vehicle rear door assembly.

### DETAILED DESCRIPTION OF EXEMPLARY EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

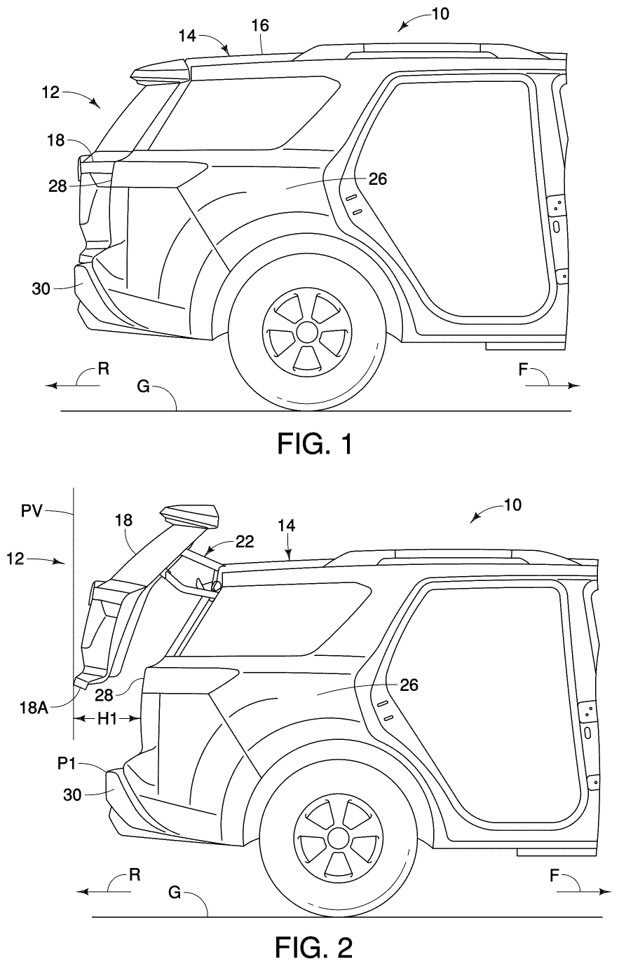

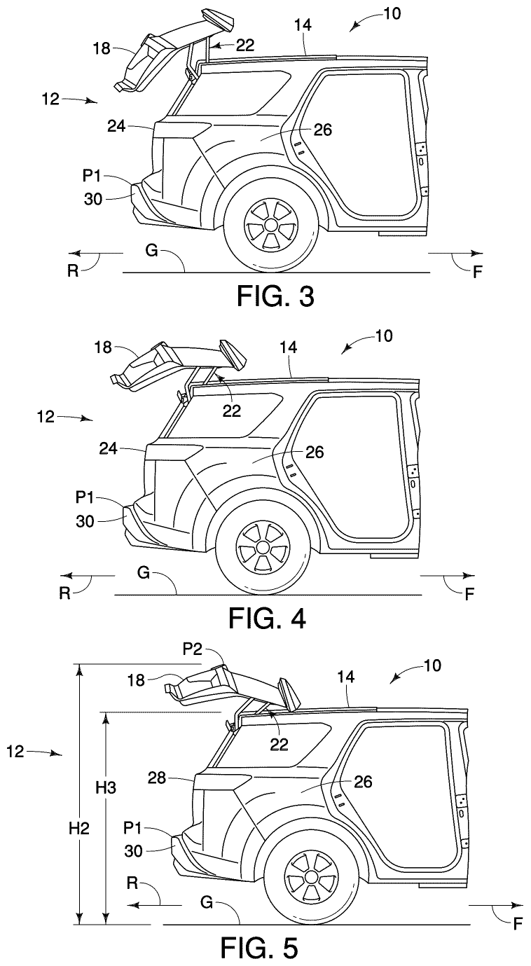

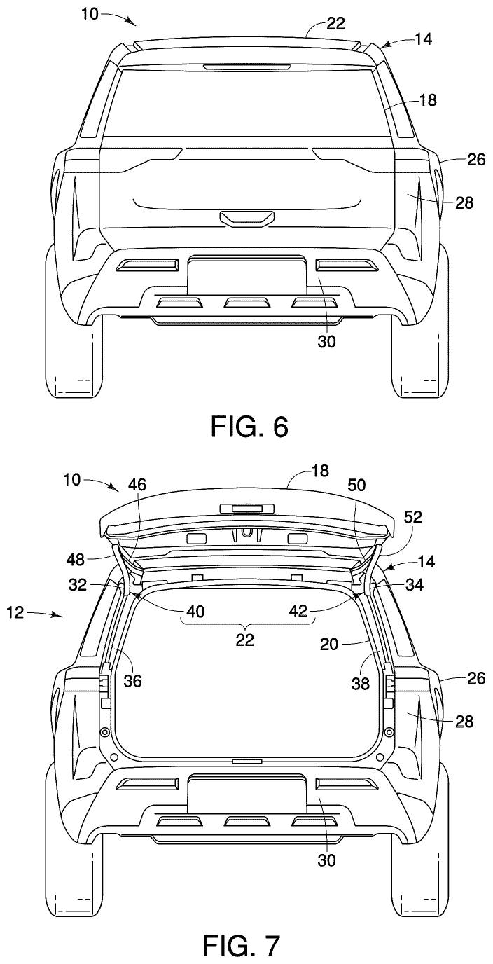

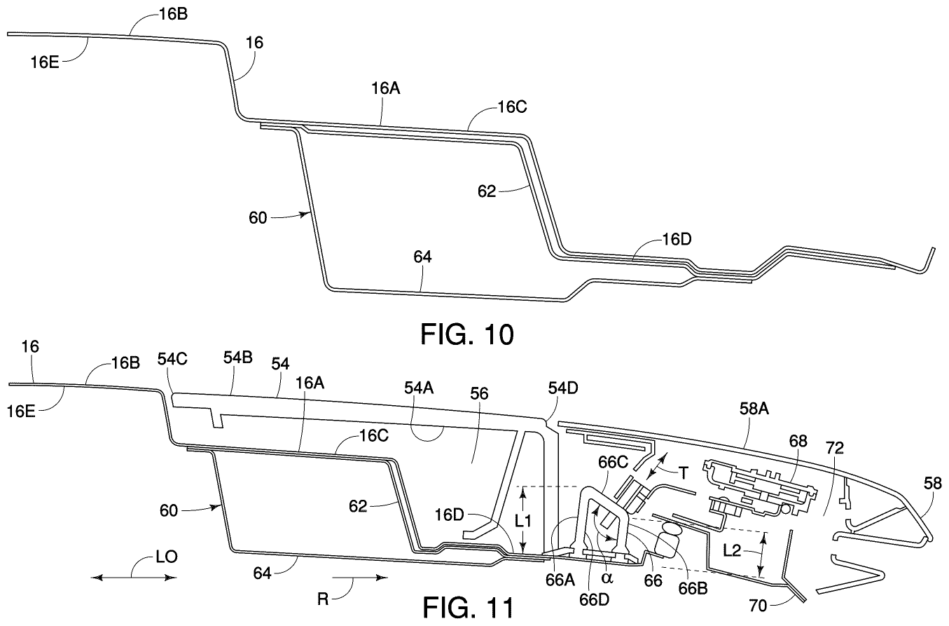

Referring initially to FIGS. 1-11 , a vehicle 10 including a rear door assembly 12 is illustrated in accordance with an exemplary embodiment. The rear door assembly 12 includes a vehicle body structure 14, a roof panel 16, and a rear door 18. The roof panel 16 is connected to the vehicle body structure 14. An opening 20 is disposed in the vehicle body structure 14. The rear door 18 is pivotally connected to the vehicle body structure 14. The rear door 18 is configured to overlay the opening 20 when the rear door 18 is in a closed position, as shown in FIGS. 1 and 6.

The rear door 18 is pivotally connected to the vehicle body structure 14 by a four-bar support mechanism, or pivoting bar mechanism, or door linkage assembly, 22. A motor 24 drives the linkage assembly 22. The linkage assembly 22 is kinematically dimensioned and configured to move the rear door 18 of the vehicle 10 from a closed position shown in FIGS. 1 and 6 to various intermediate positions shown in FIGS. 2-4 and to a fully open position shown in FIGS. 5 and 7. Alternatively, any suitable support mechanism configuration can be used, such as a two-bar mechanism that pivots about a single axis of rotation in order to support the rear door 18 for movement between a closed position and an open position.

The vehicle body structure 14 includes, among other features, side structures 26, a rear structure 28 and the roof panel 16 that are rigidly connected to one another by, for example, various welding techniques. The rear structure 28 of the vehicle body structure 14 defines the rear door opening 20.

When the rear door 18 is in the closed position, as shown in FIGS. 1 and 6, the rear door 18 covers, or overlays, the rear door opening 20. When the rear door 18 is in the fully open position, as shown in FIGS. 5 and 7, the rear door opening 20 is fully exposed to provide access to an interior of the vehicle 10.

The rear door assembly 12, and in particular, the linkage assembly 22, is configured such that the rear door 18 remains close to the rear structure 28 and the roof panel 16 of the vehicle body structure 14 during movement of the rear door 18 between the closed position and the open position.

When the rear door 18 is in a first intermediate position, as shown in FIG. 2, a lower end 18a of the rear door 18 moves a maximum distance H1 away from the rear structure 28 with little or no further rearward displacement as the rear door 18 moves upward to the fully open position. During the opening movement of the rear door 18, more than three quarters of the entire rear door 18 is located above and forward of a rearmost point P1 from the fascia of a bumper assembly 30 relative to a vertical plane PV, as shown in FIG. 2. In other words, only a small percentage of the rear door 18 displaced rearward of the bumper assembly 30. This allows a person to stand a short distance from the rear structure 28 of the vehicle 10 during opening and closing of the rear door 18, as well as allowing the rear door 18 to be opened with minimal clearance rearward of the vehicle 10. Minimizing the maximum distance H1 away from the rear structure 28 allows the rear door 18 to be opened and closed in most typical garages with a garage door closed when the distance rearward of the rear structure is greater than the distance H1. Minimizing the maximum distance H1 reduces the clearance required to open and close the rear door 18 with the garage door closed. The trajectory of conventional rear doors require the garage door to be in the open position to move the rear door 18 between the open and closed positions. The linkage assembly 22 reduces the maximum distance H1 rearward of the rear structure 28, as shown in FIG. 2.

The rear structure 28 further includes recessed areas 32 and 34, as shown in FIG. 7. The recessed areas 32 and 34 are located on opposite sides of the rear structure 28 above and at least partially outboard of the rear door opening 20. Below each of the recessed areas 32 and 34 are respective gutters 36 and 38 that extend downward from the recessed areas 32 and 34 alongside corresponding sides of the rear door opening 20.

When the rear door 18 is in the fully open position, as shown in FIGS. 5 and 7, a topmost part P2 of the rear door 18 is at a height H2 above a ground level G. The roof panel 16 is located at a height H3 above the ground level G. The height H3 is approximately 81% of the height H2. In other words, the topmost part P2 of the rear door 18, which is at the height H2, is located less than 20% above the height of the roof panel 16, which has the height H3. The rear door 18 can be opened in most typical garages where the ceiling height of the garage is greater than the height H2. The linkage assembly 22 reduces the height H2 required to move the rear door 18 to the fully open position, as shown in FIG. 5, compared to a height required to move a conventional rear door to a fully open position.

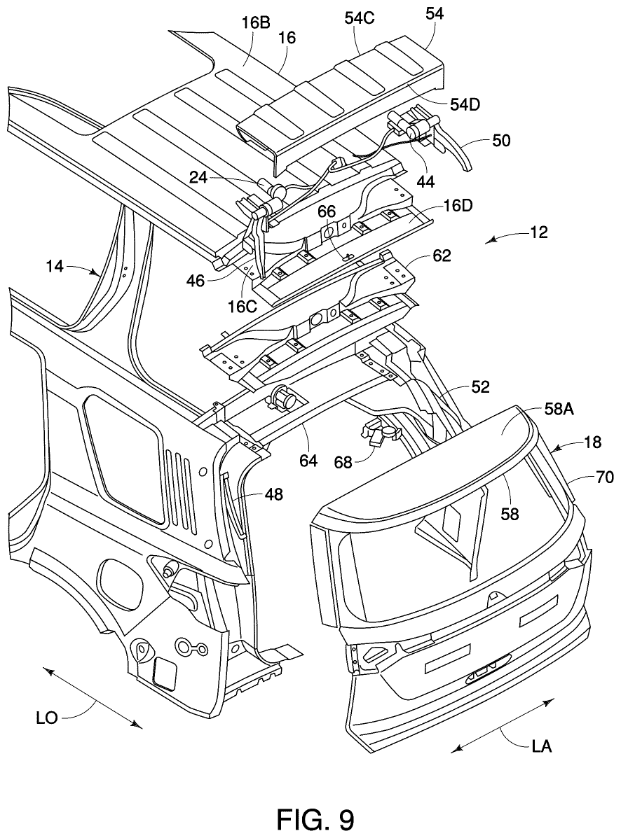

As shown in FIGS. 2-5, 7 and 9, the linkage assembly 22 includes two hinge assemblies 40 and 42. The hinge assemblies 40 and 42 are basically identical to one another, except that they are symmetrical mirror images of one another. Therefore, in the description below, although the hinge assembly 42 will occasionally be referenced, the description below will focus on the hinge assembly 40, for the sake of brevity. It should be understood from the drawings and the description herein, that the description of the hinge assembly 40 applies equally to the hinge assembly 42. Further, there are two electric motors 24 and 44, as shown in FIG. 9, located on opposite sides of the vehicle body structure 14 adjacent to opposites upper ends of the rear door opening 20. The first electric motor 24 drives the first hinge assembly 40. The second electric motor 44 drives the second hinge assembly 42. The description of the first electric motor 24 applies equally to the second electric motor 44.

Each of the first and second hinge assemblies 40 and 42 has first and second pivoting bars. The first hinge assembly 40 has first and second pivoting bars 46 and 48. The second hinge assembly 42 has first and second pivoting bars 50 and 52. The first and second hinge assemblies 40 and 42 have a total of four pivoting bars defining the four-bar support mechanism of the linkage assembly 22.

Each of the first and second hinge assemblies 40 and 42 is connected to the vehicle body structure 14 in any suitable manner, such as by a bracket. Preferably, the brackets are disposed in the recessed areas 32 and 34, as shown in FIG. 7.

As shown in FIG. 9, the first and second electric motor 24 and 44 are installed to a side rear area of the roof panel 16. Operation of the first motor 24 moves or pivots the first arm 46 and the second arm 48 of the first hinge assembly 40. Operation of the second motor 44 moves or pivots the first arm 50 and the second arm 52 of the second hinge assembly 42. The first arm 46 of the first hinge assembly 40 and the first arm 50 of the second hinge assembly 42 pivot about a first axis. The second arm 48 of the first hinge assembly 40 and the second arm 52 of the second hinge assembly 42 pivot about a second axis. The second axis is a different axis than the first axis. The first and second motors 24 and 44 cause pivotal movement of the first and second arms of the first and second hinge assemblies, which in turn cause movement of the rear door 18 between the closed position and the open position.

When the operation of the first and second motors 24 and 44 pivot the rear door 18 to the open position, as shown in FIG. 7, the rear door opening 20 is fully exposed. When the operation of the first and second motors 24 and 44 pivot the rear door 18 to the closed position, as shown in FIG. 6, the rear door opening 26 is fully covered. In the closed position, the rear door 18 is in a substantially vertical position, as shown in FIG. 1. In the fully open position, the rear door 18 is in a substantially horizontal position, as shown in FIG. 5. Preferably, at least half of the rear door 18 is located above the roof panel 16 in the fully open position.

The first and second electric motors 24 and 44 can be connected to an electronic controller (not shown) that is programmed to operate the electric motors 24 and 44 for the purpose of locking and unlocking the rear door 18 and opening and closing the rear door 18 upon receiving commands to do so from either a vehicle operator or a vehicle passenger.

For a more detailed description of the elements of the linkage assembly 22, see co-pending U.S. patent application Ser. No. 18/520,476, which was filed Nov. 27, 2023, and co-pending U.S. patent application Ser. No. 18/520,482, which was filed date Nov. 27, 2023, both of which are incorporated herein in their entirety.

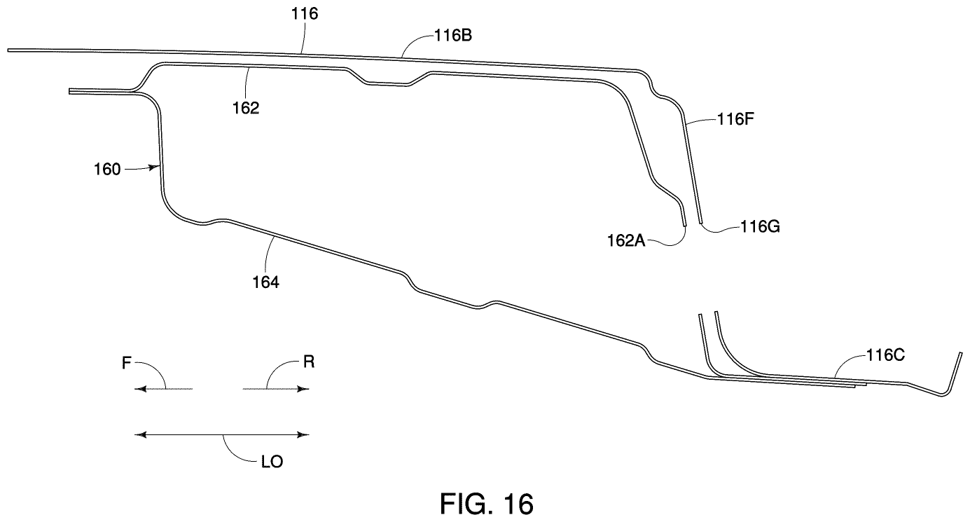

As shown in FIG. 16, the first and second electric motors 24 and 44 are connected to the roof panel 16. A cover 54 is connected to the roof panel 16. The cover 16 is connected to an outer surface 16A of the roof panel 16. The outer surface 16A of the roof panel 16 and an inner surface 54A of the cover 54 define a cavity 56. The first and second electric motors 24 and 44 are disposed in the cavity 56. The cover 54 is removable from the roof panel 16 to provide access to the first and second motors 24 and 44.

The roof panel 16 includes a first portion 16B, a second portion 16C and a third portion 16D, as shown in FIGS. 9-11. The first portion 16B extends in a longitudinal direction LO of the vehicle 10 and is disposed at a first height. The second portion 16C extends in the longitudinal direction LO of the vehicle 10 and is disposed at a second height. The third portion 16D extends in the longitudinal direction of the vehicle 10 and is disposed at a third height. The first height is above the second height, which is above the third height. In other words, the first portion 16B is further from the ground than the second portion 16C, which is further from the ground than the third portion 16D. The first portion 16B is disposed forward in the longitudinal direction LO of the vehicle of the second portion 16C, which is disposed forward of the third portion 16D. A rearward portion of the third portion 16D is disposed in the vehicle rearward direction R relative to the cover 54, as shown in FIG. 11, and functions as a water channel or trough. As shown in FIG. 9, the first striker 66 is disposed in the water trough.

An outer surface 54B at a first end 54C of the cover 54 is preferably substantially flush with the outer surface of the first portion 16B of the roof panel 16, as shown in FIG. 11. The outer surface 54B at a second end 54D of the cover 54 is preferably substantially flush with an outer surface 58A of a spoiler 58 of the rear door 18.

The roof panel 16 includes a roof bow cross member 60, as shown in FIGS. 9-11. The roof bow cross member 60 extends in the lateral direction LA of the vehicle 10 to support the roof panel 16. The roof bow cross member 60 includes a first panel 62 and a second panel 64. The cross member 60 is connected to the vehicle body structure 14 and to a lower surface 16E of the roof panel 16.

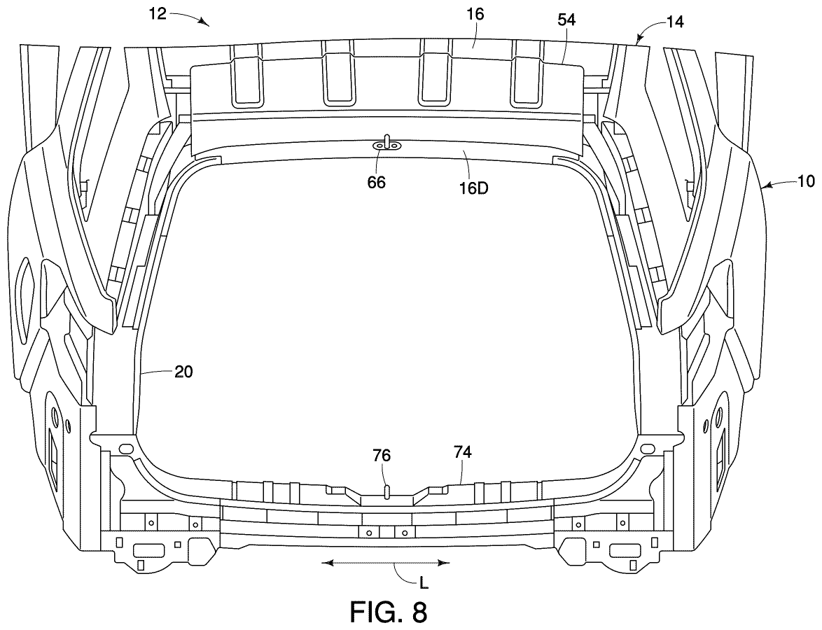

A first striker 66 is connected to the roof panel 16, as shown in FIGS. 8, 9 and 11. The first striker 66 is connected to the outer surface 16A of third portion 16D of the roof panel 16. The first striker 66 is substantially centered on the roof panel 16 in a lateral direction LA of the vehicle 10, as shown in FIG. 8.

The first striker 66 has a first leg 66A, a second leg 66B, and a connecting leg 66C, as shown in FIG. 11. The first let 66A, the second leg 66B, the connecting leg 66C, and the third portion 16D of the roof panel 16 define an opening 66D in the first striker 66. The opening 66D faces the lateral direction LA of the vehicle 10. A first length L1 of the first leg 66A is longer than a second length L2 of the second leg 66B. An angle α is defined between the connecting leg 66C and the second leg 66B. The angle α is preferably between approximately 120-130 degrees. More preferably, the angle α is preferably approximately 125.6 degrees. As shown in FIGS. 1 and 2, movement of the rear door 18 to and from the closed position is substantially perpendicular to the connecting leg 66C of the first striker 66. In other words, the connecting leg 66C is disposed substantially perpendicularly to a travel direction T of the rear door 18 between the open and closed positions.

As shown in FIG. 11, the first striker 66 is disposed in the vehicle rearward direction R of the cross bow member 60. As shown in FIGS. 8 and 11, the first striker 66 is disposed in the vehicle rearward direction R of the cover 54.

A first latch member 68 is connected to the rear door 18, as shown in FIGS. 9 and 11. The first latch member 68 is configured to engage the first striker 66 upon moving the rear door 18 to the closed position, as shown in FIGS. 1, 6 and 11. The first latch member 68 is configured to disengage the first striker 66 upon moving the rear door 18 to an open position, as shown in FIGS. 2-5 and 7. The first latch member 68 is any suitable latch member. Preferably, the first latch member 68 is a cinching latch.

The rear door 18 includes a panel 70 and the spoiler 58, as shown in FIGS. 9 and 11. The spoiler 58 is connected to the panel 70 of the rear door 18. The first latch member 68 is disposed in a cavity 72 defined by the panel 70 and the spoiler 58, as shown in FIG. 11. The first latch member 68 is connected to the panel 70 of the rear door 18. An opening is disposed in the panel 70 such that a portion of the first latch member 68 extends therethrough, as shown in FIG. 11. In other words, the portion of the first latch member 68 extending through the opening is disposed externally of the cavity 72. The exposed portion of the first latch member 68 is configured to engage the first striker 66 upon moving the rear door 18 to the closed position, as shown in FIGS. 1 and 6.

A bottom panel 74 is connected to the vehicle body structure 14, as shown in FIG. 8. A second striker 76 is connected to the bottom panel 74. The second striker 76 is preferably aligned with the first striker 66 in the lateral direction LA of the vehicle. The first and second strikers 66 and 76 are substantially centered in the lateral direction LA of the vehicle 10.

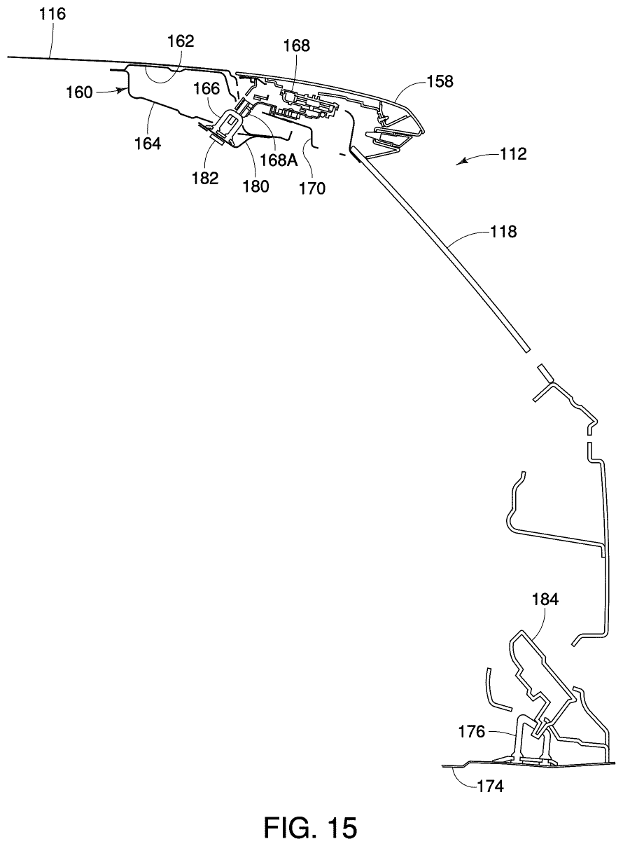

A second latch member (184, FIG. 15) is connected to the rear door 18. The second latch member is configured to engage the second striker 76 upon moving the rear door 18 to the closed position, as shown in FIGS. 1 and 6. The second latch member is configured to disengage the second striker 76 upon moving the rear door 18 to the open position, as shown in FIGS. 2-5 and 7. The second latch member is any suitable latch member, such as a slam latch. Preferably, the second latch member is a different type of latch member than the first latch member 68, such as the first latch member 68 being a cinching latch and the second latch member 184 (FIG. 15) being a slam latch.

The first latch member 68 is configured to engage the first striker 66 and the second latch member 184 (FIG. 15) is configured to engage the second striker 76 upon moving the rear door 18 to the closed position, as shown in FIGS. 1 and 6. The first latch member 68 is configured to disengage the first striker 66 and the second latch member 184 (FIG. 15) is configured to disengage the second striker 76 upon moving the rear door 18 to the open position, as shown in FIGS. 2-5 and 7.

The rear door assembly 12, as shown in FIGS. 1-11, is provided with a first striker 66 connected to the roof panel 16 to facilitate securing the rear door 18 to the vehicle body structure 14 in the closed position. Providing a first striker 66 connected to the roof panel 16 and a second striker connected to a bottom panel 74 further facilitates securing the rear door 18 to the vehicle body structure 14 in the closed position.

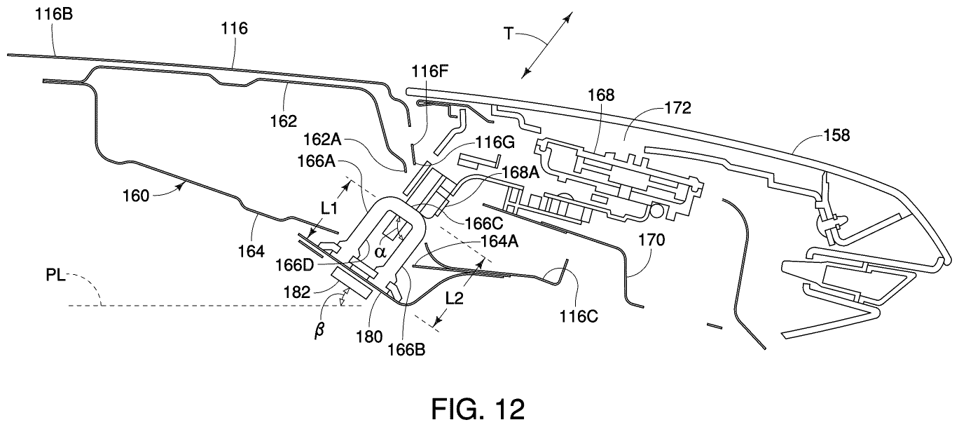

As shown in FIGS. 12-16, a rear door assembly 112 in accordance with another illustrated exemplary embodiment is substantially similar to the rear door assembly 12 of the exemplary embodiment illustrated in FIGS. 1-11 except for the differences described below. Similar parts are identified with similar reference numerals, except increased by 100 (i.e., 1xx, accordingly).

The rear door assembly 112 illustrated in FIGS. 12-16 is substantially similar to the rear door assembly 12 of FIGS. 1-11 except for the configuration of the first striker 166, the first engagement member 168, the roof panel 116 and the roof bow cross member 160.

As shown in FIGS. 12, 15 and 16, the roof panel 116 includes a first portion 116B, and a second portion 116C. The first portion 116B extends in a longitudinal direction LO of the vehicle and is disposed at a first height. The second portion 116C extends in the longitudinal direction LO of the vehicle and is disposed at a second height. A connecting panel 116F extends between the first panel 116B and the second panel 116C. The connecting panel 116F extends substantially vertically between the first panel 116B and the second panel 116C. The first height is above the second height. In other words, the first portion 116B is further from the ground than the second portion 116C. The first portion 116B is disposed forward in the longitudinal direction LO of the vehicle of the second portion 116C. In other words, the first portion 116B is disposed forward of the second portion 116C in the vehicle forward direction F. An opening 116G is disposed in the connecting panel 116F, as shown in FIGS. 15 and 16.

A roof bow cross member 160 extends in the lateral direction LA (FIG. 9) of the vehicle to support the roof panel 116, as shown in FIGS. 12, 15 and 16. The roof bow cross member 160 includes a first panel 162 and a second panel 164. The cross member 160 is connected to the vehicle body structure 14 (FIG. 9) and to the roof panel 116 and is disposed below the roof panel 116 to support the roof panel 116. An opening 162A is disposed in the first panel 162, and an opening 164A is disposed in the second panel 164, as shown in FIG. 12, to receive the first striker 166.

A bracket 180 is connected to the second panel 164 of the cross member 160, as shown in FIGS. 12, 14 and 15. The bracket 180 includes a support member 182 to secure the first striker 166 to the bracket 180.

The first striker 166 is connected to the roof panel 116, as shown in FIG. 15. The first striker 166 is connected to the second panel 164 of the cross member 160. The cross member 160 is connected to a lower surface of the roof panel 116. The first striker 166 is substantially centered on the roof panel 116 in a lateral direction LA of the vehicle.

The first striker 166 has a first leg 166A, a second leg 166B, and a connecting leg 166C, as shown in FIG. 12. The first leg 166A, the second leg 166B, the connecting leg 166C, and the bracket 180 define an opening 166D in the first striker 166. The opening 166D faces the lateral direction LA of the vehicle. A first length L1 of the first leg 166A is substantially equal to a second length L2 of the second leg 166B. An angle α is defined between the connecting leg 166C and the second leg 166B. The angle α is preferably approximately 90 degrees. An angle β is defined between the bracket 180 and a horizontal plane P, as shown in FIG. 12. The angle β is between approximately 30 and approximately 40 degrees. The angle β is preferably approximately 35.6 degrees.

As shown in FIGS. 1 and 2, movement of the rear door 118 to and from the closed position is substantially perpendicular to the connecting leg 166C of the first striker 166. In other words, the connecting leg 166C is disposed substantially perpendicularly to a travel direction T of the rear door 118 between the open and closed positions.

As shown in FIGS. 12 and 15, the first striker 166 passes through an opening 164A in the second panel 164 and through an opening 162A in the first panel 162 of the cross member 160. In other words, the first striker 166 passes through an opening in the roof bow cross member 160. The opening 162A in the first panel 162 of the cross member 160 provides access to the first striker 166 by the first latch member 168.

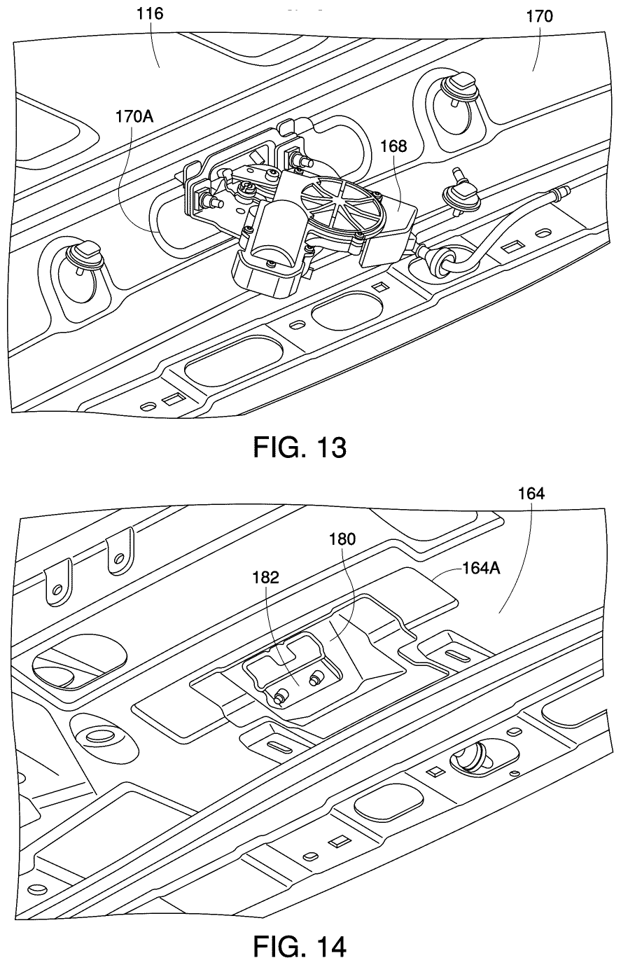

The first latch member 168 is connected to the rear door 118, as shown in FIGS. 12 and 15. The first latch member 168 is configured to engage the first striker 166 upon moving the rear door 118 to the closed position, as shown in FIGS. 13 and 15. The first latch member 168 is configured to disengage the first striker 166 upon moving the rear door 118 to an open position, as shown in FIGS. 2-5 and 7. The first latch member 168 is any suitable latch member. Preferably, the first latch member 168 is a cinching latch.

The rear door 118 includes a panel 170 and the spoiler 158, as shown in FIGS. 12 and 15. The spoiler 158 is connected to the panel 170 of the rear door 118. The first latch member 168 is disposed in a cavity 172 defined by the panel 170 and the spoiler 158, as shown in FIG. 12. An opening 170A is disposed in the panel 170 such that a portion 168A of the first latch member 168 extends therethrough, as shown in FIGS. 12 and 13. In other words, the portion 168A of the first latch member 168 extending through the opening 170A is disposed externally of the cavity 172.

As shown in FIG. 16, the opening 116G disposed in the connecting panel 116F of the roof panel 116 is aligned with the opening 162A in the first panel 162 of the cross member 160 in the travel direction T of the rear door 118. In other words, a virtual line extending in the travel direction of the rear door 118 passes through the opening 116G in the connecting panel 116F of the roof panel 116 and through the opening 162A in the first panel 162 of the cross member 160. When the rear door 118 is moved to the closed position, as shown in FIGS. 12, 13 and 15, the portion 168A of the first latch member 168 passes through the opening 116G in the connecting panel 116F of the roof panel 116 and through the opening in the first panel 162 of the cross member 160 to engage the first striker 166.

A bottom panel 174 is connected to the vehicle body structure 14 (FIG. 8). A second striker 176 is connected to the bottom panel 174, as shown in FIG. 15. The second striker 176 is preferably aligned with the first striker 166 in the lateral direction LA of the vehicle (FIG. 8). In other words, the first and second strikers 166 and 176 are substantially centered in the lateral direction LA of the vehicle.

A second latch member 184 is connected to the rear door 118, as shown in FIG. 15. The second latch member 184 is configured to engage the second striker 176 upon moving the rear door 118 to the closed position. The second latch member 184 is configured to disengage the second striker 176 upon moving the rear door 118 to the open position. The second latch member is any suitable latch member, such as a slam latch. Preferably, the second latch member is a different type of latch member than the first latch member, such as the first latch member 168 being a cinching latch and the second latch member 184 being a slam latch.

The first latch member 168 is configured to engage the first striker 166 and the second latch member 184 is configured to engage the second striker 176 upon moving the rear door 118 to the closed position, as shown in FIG. 15. The first latch member 168 is configured to disengage the first striker 166 and the second latch member 184 is configured to disengage the second striker 176 upon moving the rear door 118 to the open position.

The rear door assembly 112, as shown in FIGS. 12-16, is provided with a first striker 166 connected to the roof panel 116 to facilitate securing the rear door 118 to the vehicle body structure 114 in the closed position. Providing a first striker 166 connected to the roof panel 116 and a second striker 176 connected to a bottom panel 174 further facilitates securing the rear door 118 to the vehicle body structure 114 in the closed position.

The various vehicle body structures, other than those features specifically described above, are conventional components that are well known in the art. Since these body structures are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle equipped with the vehicle rear door structure. Accordingly, these terms, as utilized to describe the present invention should be interpreted relative to a vehicle equipped with the vehicle rear door structure.

The term “configured” as used herein to describe a component, section or part of a device that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A rear door assembly for a vehicle, the rear door assembly comprising:
a vehicle body structure;
a roof panel connected to the vehicle body structure;
an opening disposed in the vehicle body structure;
a first striker connected to the roof panel; and
a rear door pivotally connected to the vehicle body structure and configured to overlay the opening in a closed position;
a linkage assembly pivotally connecting the rear door to the vehicle body structure;
a motor configured to drive the linkage assembly; and
a first latch member connected to the rear door, the first latch member being configured to engage the first striker upon moving the rear door to the closed position, and the first latch member being configured to disengage the first striker upon moving the rear door to an open position,
the first striker being disposed rearward of the motor in a vehicle longitudinal direction.

2. The rear door assembly according to claim 1, wherein
the first striker is substantially centered on the roof panel in a lateral direction of the vehicle.

3. The rear door assembly according to claim 1, wherein
the first striker has a first leg, a second leg, and a connecting leg connecting the first and second legs, a first length of the first leg being longer than a second length of the second leg.

4. The rear door assembly according to claim 3, wherein
the connecting leg of the first striker being disposed substantially perpendicularly to a travel direction of the rear door between the open and closed positions.

5. The rear door assembly according to claim 4, wherein
an angle of approximately 125.6 degrees is formed between the connecting leg and the second leg of the first striker.

6. The rear door assembly according to claim 1, wherein
the first striker is disposed rearward of a roof bow cross member.

7. The rear door assembly according to claim 1, wherein
the rear door includes a panel and a spoiler connected to the panel, the first latch being disposed in a cavity defined by the panel and the spoiler.

8. The rear door assembly according to claim 1, wherein
a bottom panel is connected to the vehicle body structure, and
a second striker is connected to the bottom panel.

9. The rear door assembly according to claim 7, wherein
a second latch member is connected to the rear door, the second latch member being configured to engage the second striker upon moving the rear door to the closed position, and the second latch member being configured to disengage the second striker upon moving the rear door to an open position.

10. The rear door assembly according to claim 1, wherein
the first striker has a first leg, a second leg, and a connecting leg connecting the first and second legs, a first length of the first leg being substantially equal to a second length of the second leg.

11. The rear door assembly according to claim 10, wherein
the connecting leg of the first striker is disposed substantially perpendicularly to a travel direction of rear door between the open and closed positions.

12. The rear door assembly according to claim 11, wherein
an angle of approximately 90 degrees is formed between the connecting leg and the second leg of the first striker.

13. The rear door assembly according to claim 10, wherein
the first striker passes through an opening in a roof bow cross member.

14. A rear door assembly for a vehicle, comprising:
a vehicle body structure;
a roof panel connected to the vehicle body structure;
a bottom panel is connected to the vehicle body structure;
an opening disposed in the vehicle body structure;
a first striker connected to the roof panel;
a second striker connected to the bottom panel;
a rear door overlaying the opening in a closed position;
a first latch member connected to the rear door; and
a second latch member connected to the rear door, the second latch member being a different type of latch member than the first latch member,
the first latch member being configured to engage the first striker and the second latch member being configured to engage the second striker upon moving the rear door to the closed position, and the first latch member being configured to disengage the first striker and the second latch member being configured to disengage the second striker upon moving the rear door to an open position.

15. The rear door assembly according to claim 14, wherein
the first striker is substantially centered on the roof panel in a lateral direction of the vehicle.

16. The rear door assembly according to claim 15, wherein
the first striker has a first leg, a second leg, and a connecting leg connecting the first and second legs, a first length of the first leg being longer than a second length of the second leg.

17. The rear door assembly according to claim 16, wherein
the connecting leg of the first striker being disposed substantially perpendicularly to a travel direction of the rear door between the open and closed positions.

18. The rear door assembly according to claim 1, wherein
the first striker is disposed rearward of a roof bow cross member.

19. The rear door assembly according to claim 15, wherein
the first striker has a first leg, a second leg, and a connecting leg connecting the first and second legs, a first length of the first leg being substantially equal to a second length of the second leg.

20. The rear door assembly according to claim 19, wherein
the first striker passes through an opening in a roof bow cross member.
